(19) United States
(12) Patent Application Publication
(10) Pub. No.: US 2025/0029754 A1
(43) Pub. Date: Jan. 23, 2025

(54) PRINTING CHIP RESISTOR AND METHOD FOR PRODUCING THE SAME

(71) Applicant: YAGEO CORPORATION, Kaohsiung City (TW)

(72) Inventors: Shen-Li HSIAO, Kaohsiung City (TW); Kuang-Cheng LIN, Kaohsiung City (TW); Ren-Hong WANG, Kaohsiung City (TW)

(21) Appl. No.: 18/489,283

(22) Filed: Oct. 18, 2023

(30) Foreign Application Priority Data
Jul. 17, 2023 (TW) 112126523

(51) Int. Cl. H01C 1/14; H01C 7/00; H01C 17/28

(52) U.S. Cl. CPC H01C 1/14; H01C 7/00; H01C 17/281

(57) ABSTRACT

The present application relates to a printing chip resistor and a method for producing the same. The printing chip resistor comprises a substrate, a resistor layer, a lower electrode and an upper electrode. The resistor layer is disposed over a top surface of the substrate, the lower electrode is disposed between the substrate and the resistor layer, and the resistor layer is disposed between the upper electrode and the lower electrode. The specific construction of the printing chip resistor facilitates to enlarge conducting cross-section area and shorten conducting length of the chip resistor, thereby meeting requirements of lower resistor value and improving heat dissipation efficacy of the printing chip resistor.

### RELATED APPLICATIONS

This application claims priority to Taiwan Application Serial Number 112126523, filed on Jul. 17, 2023, which is incorporated herein by reference.

### BACKGROUND

### Field of Invention

The application relates to a printing chip resistor. More particularly, the present application provides a printing chip resistor with low resistance and good heat dissipation efficacy and a method for producing the same.

### Description of Related Art

With a development trend of miniaturization of electronic products, active and passive components in those are reduced. Printing chip resistors are also common passive components in the electronic products. A resistor layer of the printing chip resistors is generally formed from a resistive paste, and the resistive paste includes compositions such as resistive functional powders, glass powders, ceramic powders, inorganic firing aids and organic matters. Because the glass powders, the ceramic powders and the inorganic firing aids still have higher resistance value after sintering, amounts of resistance functional powders are generally increased or conductive precious metals (such as palladium, silver or the like) are additionally added for meeting requirements of low resistance value. However, both of the increasing of the amounts of the resistance functional powders and the adding of the conductive precious metals increase costs.

Moreover, electrodes of general printing chip resistors are disposed at two ends of the resistor layer, and therefore heat energy generated from current passed though the resistor layer is merely dissipated through a ceramic substrate with a lower thermal conductivity (about 17 W/mK). Accordingly, stress variation of the resistor layer is easily generated due to accumulated heat energy when there is a current surge or being applied in high power, and thereby resistance values are abnormal.

Accordingly, there is an urgent need to provide a printing chip resistor and a method for producing the same to improve the defects of the conventional printing chip resistor.

### SUMMARY

Therefore, an aspect of the present application is to provide a printing chip resistor. The printing chip resistor comprises a resistor body with a specific structure, thereby increasing a conduction cross-sectional area of the resistor and shortening its path length, further meeting application requirements of low resistance properties, and the specific structure facilitates to improve heat dissipation efficacy of the printing chip resistor. Therefore, it can prevent the influence resulted from variations of thermal stresses.

Another aspect of the present application is to provide a method for producing a printing chip resistor. The printing chip resistor of the present application is formed by specific producing processes. Therefore, it can meet requirements of products with low resistance properties, and it facilitates to prevent abnormal resistance defects resulted from the variations of the thermal stresses.

According to an aspect of the present application, a printing chip resistor is provided. The printing chip resistor comprises a substrate, a resistor layer, a lower electrode and an upper electrode. The resistor layer is disposed on a top surface of the substrate. Along a direction perpendicular to the top surface, the lower electrode is disposed between the substrate and the resistor layer, and the resistor layer is disposed between the upper electrode and the lower electrode.

According to some embodiments of the present application, at least one portion of the aforementioned upper electrode overlaps at least one portion of the lower electrode.

According to some embodiments of the present application, the aforementioned resistor layer covers an overlapping area corresponding to the overlapping of the upper electrode and the lower electrode.

According to some embodiments of the present application, the aforementioned upper electrode and lower electrode are respectively located at two ends of the substrate.

According to some embodiments of the present application, the aforementioned top surface is a square having a first side and a second side, and the first side is perpendicular to the second side. Along an extending direction of the first side, a length of the lower electrode is not greater than

$$\frac{4}{5} L 1 ,$$

and L1 represents a length of the first side. Along an extending direction of the second side, a length of the lower electrode is not greater than

$$\frac{4}{5} L 2 ,$$

and L2 represents a length of the second side.

According to some embodiments of the present application, the aforementioned first side is longer than the second side. Along the extending direction of the first side, the length of the lower electrode is not less than

$$\frac{1}{3} L 1$$

According to some embodiments of the present application, the aforementioned printing chip resistor further comprises a protective layer, two back electrodes and two terminal electrodes. The protection layer is disposed on the upper electrode, and the protection layer completely covers the resistor layer. The two back electrodes are respectively disposed at two ends on a bottom surface of the substrate. The two terminal electrodes are respectively disposed on two ends of the substrate. One of the two terminal electrodes is electrically connected to one of the two back electrodes and the lower electrode, and another one of the two terminal electrodes is electrically connected to another one of the two back electrodes and the upper electrode.

According to another aspect of the present application, a method for producing a printing chip resistor is provided. A lower electrode is firstly formed on a top surface of a substrate, and then a resistor layer is formed on the lower electrode. Next, an upper electrode is formed on the resistor layer to form a resistor body of the printed chip resistor of the present application. Along a direction perpendicular to the top surface, at least one portion of the upper electrode overlaps at least one portion of the lower electrode.

According to some embodiments of the present application, after forming the aforementioned resistor body, a resistance modifying operation is performed to the upper electrode and/or the lower electrode.

According to some embodiments of the present application, after forming the aforementioned resistor body, a protective layer is formed on the upper electrode, and the protective layer completely covers the resistor layer. Then, two back electrodes are formed on a bottom surface of the substrate, and the two back electrodes are respectively located at two ends of the bottom surface. And then, two terminal electrodes are respectively formed on two ends of the substrate to form the printing chip resistor of the present application. One of the two terminal electrodes is electrically connected to one of the back electrodes and the lower electrode, and another one of the two terminal electrodes is electrically connected to another one of the two back electrodes and the upper electrode.

According to an aspect of the present application, a printing chip resistor is provided. The printing chip resistor comprises a substrate, a lower electrode, an upper electrode and a resistor layer. The lower electrode is disposed on a top surface of the substrate, and the lower electrode is located at a first side of the substrate. The upper electrode is disposed on the lower electrode, and the upper electrode is located at a second side of the substrate. The first side is different from the second side. The resistor layer is disposed between the lower electrode and the upper electrode, and the upper electrode and the lower electrode are electrically insulative. Along a direction perpendicular to the top surface, a projective area of the resistor layer covers an overlapping area where a projective area of the upper electrode overlaps a projective area of the lower electrode.

According to some embodiments of the present application, the first side and the second side are opposite sides of the top surface of the substrate.

According to some embodiments of the present application, the aforementioned projective area of the resistor layer is not smaller than the overlapping area.

According to some embodiments of the present application, the aforementioned projective area of the resistor layer completely covers the overlapping area.

According to some embodiments of the present application, the aforementioned upper electrode and the resistor layer are directly disposed on the top surface of the substrate.

According to some embodiments of the present application, the upper electrode and the resistor layer respectively includes a base portion and an extension portion. The base portion is directly disposed on the top surface of the substrate. Along the direction perpendicular to the top surface, a projective area of the extension portion of the resistor layer, a projective area of the extension portion of the upper electrode and the projective area of the lower electrode are overlapping each other.

In the printing chip resistor and the method for producing the same of the present application, the resistor layer is disposed between the two electrodes to form the resistor body with a three-dimensional structure, thereby enlarging the conduction cross-sectional area of the printing chip resistor and shortening the path length. Therefore, the printing chip resistor of the present application can meet the requirements of low resistance value without adjusting the materials of the resistor layer. Moreover, heat energy generated from the resistor layer disposed between the upper electrode and the lower electrode can be dissipated through the electrodes, thereby providing a better heat dissipation efficacy, further achieving properties of efficiently resisting current surges. Besides, the resistance modifying operation can be performed to at least one of the upper electrode and the lower electrode to efficiently modify resistance properties of the printing chip resistor and prevent the resistor layer from thermal damages resulted from heat energy.

### BRIEF DESCRIPTION OF THE DRAWINGS

The invention can be more fully understood by reading the following detailed description of the embodiment, with reference made to the accompanying drawings as follows:

FIG. 1 illustrates a flow chart of a method for producing a printing chip resistor according to some embodiments of the present application.

FIG. 2A and FIG. 2B respectively illustrates a schematic cross-sectional view and a schematic top view of a resistor body of the printing chip resistor according to some embodiments of the present application.

FIG. 2C and FIG. 2D respectively illustrates a schematic top view of the resistor body of the printing chip resistor according to some embodiments of the present application.

FIG. 3A and FIG. 3B respectively illustrates a schematic cross-sectional view and a schematic top view of a printing chip resistor according to some embodiments of the present application.

FIG. 4A and FIG. 4B respectively illustrates a schematic cross-sectional view and a schematic top view of a printing chip resistor according to some embodiments of the present application.

FIG. 5 illustrates a schematic cross-sectional view of a printing chip resistor according to some embodiments of the present application.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

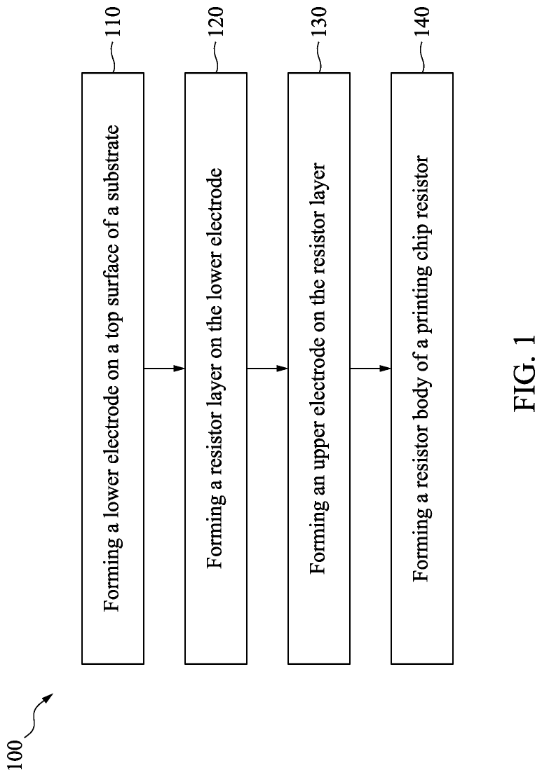

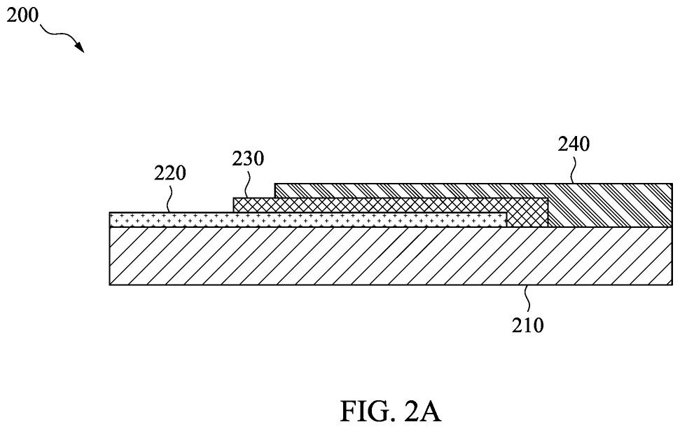

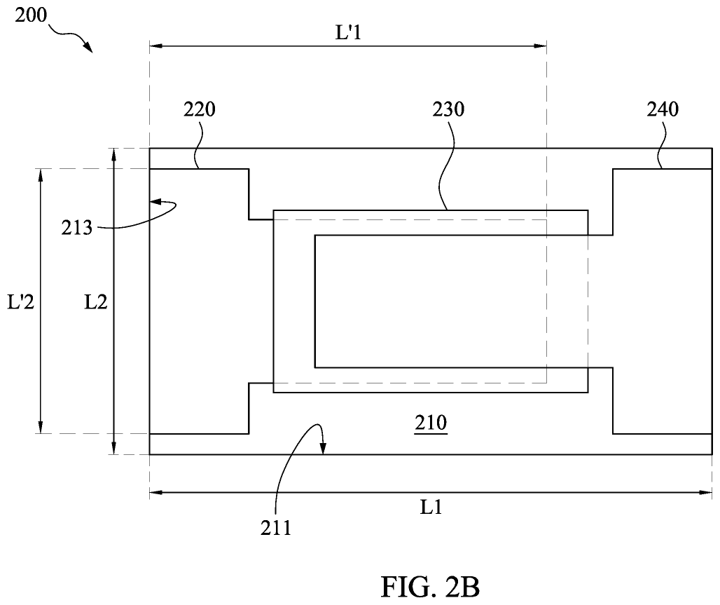

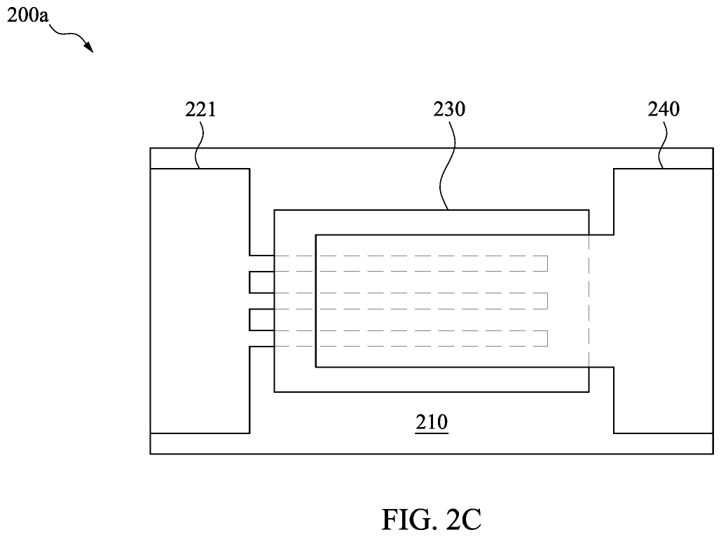

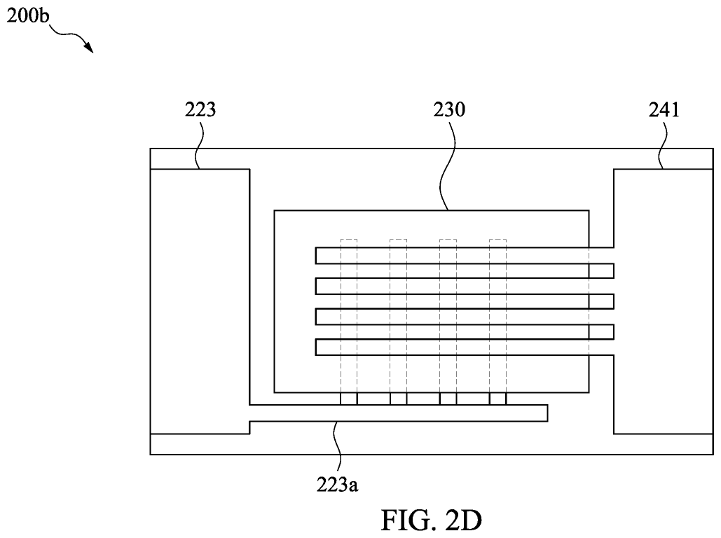

Referring to FIG. 1 together with FIG. 2A and FIG. 2B. FIG. 1 illustrates a flow chart of a method for producing a printing chip resistor according to some embodiments of the present application, and FIG. 2A and FIG. 2B respectively illustrates a schematic cross-sectional view and a schematic top view of a resistor body 200 of the printing chip resistor according to some embodiments of the present application. In a method 100, a lower electrode 220 is firstly formed on a top surface of a substrate 210, shown as operation 110. There are no specific limitations to materials of the substrate 210 as long as the substrate 210 can be used to carry electrodes, resistor layers and various structural layers of the printing chip resistor without affecting properties of the chip resistor. In some examples, the material of the substrate 210 can include but be not limited to aluminum oxide (Al₂O₃), aluminum nitride (AlN), other suitable materials or combinations thereof.

The lower electrode 220 can be formed on one end of the substrate 210 by printing a conductive electrode paste and then sintering. In some examples, the conductive electrode paste can be a composition of silver and glass paste, and a sintering temperature may be, for example, 600° C. to 850° C. In some embodiments, a thickness of the lower electrode 220 can be 10 μm to 30 μm. Methods for producing the lower electrode 220 are well known to one skilled in the art rather than focusing or mentioning them in details.

There are no specific limitations to a shape of the aforementioned substrate 210 as long as it can meet requirements of back-end applications. In some embodiments, the substrate 210 can be, for example, a square including a side 211 and a side 213 perpendicular to each other, and the side 211 and the side 213 respectively have a length L1 and a length L2. Along an extending direction of the side 211, a length L′1 of the lower electrode 220 is not greater than

$$\frac{4}{5} L 1 ,$$

and preferably is greater than or equal to

$$\frac{1}{3} L 1$$

and less than or equal to

$$\frac{4}{5} L 1.$$

If the length L′1 is greater than

$$\frac{4}{5} L 1 ,$$

the obtained resistor body 200 is easily equipped with short-circuit defects and is hard to meet the requirements of the application though the lower electrode 220 can be electrically insulated to an upper electrode 240 with a resistor layer 230. When the length L′1 is greater than or equal to

$$\frac{1}{3} L 1$$

and less than or equal to

$$\frac{4}{5} L 1 ,$$

the lower electrode 220 has a more suitable dimension, thereby efficiently increasing a conduction cross-sectional area of the resistor and shortening its path length, and further it can meet the requirements of low resistance value. Along an extending direction of the side 213, a length L′2 of the lower electrode 220 is not greater than

$$\frac{4}{5} L 2.$$

It can be realized that there are no specific limitations to a lower limit of the length L′2 as long as being greater than 0 for the lower electrode 220.

After the operation 110 is performed, a resistor layer 230 is formed on the lower electrode 220, shown as operation 120. The resistor layer 230 can be formed by printing a resistive paste and then sintering. In some examples, materials of the resistive paste can include but be not limited to ruthenium oxide (RuO₂), nickel oxide (NiO), manganese oxide (Mn₃O), zinc oxide (ZnO), iron oxide (Fe₃O₄), cobalt oxide (CO₃O₄), copper-manganese-tin alloy (Zeranin), manganese-copper alloy (Manganin), copper-nickel alloy (CuNi44), nickel-chromium-aluminum-silicon alloy, nickel-chromium alloy (NiCr), other suitable resistance materials or a combination thereof, and a sintering temperature can be, for example, 600° C. to 850° C. In some embodiments, a thickness of the resistor layer 230 can be 10 μm to 30 μm. Methods for producing the resistor layer 230 are well known to one skilled in the art rather than focusing or mentioning them in details.

A disposed position of the resistor layer 230 is not particularly limited. Preferably, it is disposed corresponding to a middle position of the substrate 210 and completely covers a portion of the lower electrode 220, and therefore a short circuit does not present between the lower electrode 220 and a subsequently formed upper electrode 240. There are no specific limitations to a shape and a dimension of the resistor layer 230 as long as it can meet the requirements of back-end applications. In some examples, along an extending direction of the side 211, a length of the resistor layer 230 is not greater than

$$\frac{3}{5} L 1.$$

When the length of the resistor layer 230 is not greater than

$$\frac{3}{5} L 1 ,$$

the resistor layer 230 can not only provide a better insulation efficacy for the lower electrode 220 and the upper electrode 240, but also efficiently reduce manufacturing costs of the printing chip resistor.

After the operation 120 is performed, an upper electrode 240 is formed on the resistor layer 230 to obtain a resistor body 200 of the printing chip resistor of the present application, shown as operation 130 and operation 140. The upper electrode 240 can be produced with the same method and the same material as the lower electrode 220, and the upper electrode 240 can have the same or different dimensions from the lower electrode 220.

In the resistor body 200, the upper electrode 240 and the lower electrode 220 are respectively located at opposite ends of the substrate 210, and the resistor layer 230 is disposed between the lower electrode 220 and the upper electrode 240 along a direction perpendicular to the top surface of the substrate 210. In some embodiments, at least one portion of the upper electrode 240 overlaps at least one portion of the lower electrode 220. In these embodiments, corresponding to an overlapping area of the lower electrode 220 and the upper electrode 240, the resistor layer 230 covers the overlapping range. An area of the resistor layer 230 is not smaller than that of the overlapping range. Preferably, the area of the resistor layer 230 is larger than that of the overlapping range.

Although the lower electrode 220 and the upper electrode 240 shown as FIG. 2B are T-shaped, the present application is not limited thereto. In other embodiments, the lower electrode 220 and the upper electrode 240 can have other suitable shapes. For example, as shown in FIG. 2C, the lower electrode 221 of the resistor body 200a has comb-shaped portions connected in parallel, and along a direction perpendicular to the top surface of the substrate 210, a portion of the comb-shaped portions overlaps the upper electrode 240; as shown in FIG. 2D, the upper electrode 241 of the resistor body 200b has comb-shaped portions connected in parallel, and the lower electrode 223 has an extension portion 223a and comb-shaped portions protruding from the extension portion 223a. Along a direction perpendicular to the top surface of the substrate 210, the comb-shaped portions of the upper electrode 241 and the comb-shaped portions of the lower electrode 223 have a plurality of overlapping portions.

Referring to FIG. 1 together with FIG. 2B, FIG. 2C and FIG. 2D. After the operation 140 is performed, a resistance modifying operation is selectively performed to the upper electrode 240 and/or the lower electrode 220 of the resistor body 200, thereby further adjusting resistance performances of the resistor body 200 to meet requirements of the application. For example, the resistance modifying operation can be processed with a laser to remove at least one portion of the upper electrode 240 and/or the lower electrode 220 to more finely adjust electrical performances of the printing chip resistor. For a structure shown as FIG. 2C, it can be realized that the laser, corresponding to a position of the lower electrode 220, is directly applied to the lower electrode 220 or applied to the resistor layer 230 which covers the lower electrode 220 when the resistance modifying operation is performed to the lower electrode 220; the laser applied to the upper electrode 240 is not only limited to remove a portion of the upper electrode 240 but also remove a portion or an entire of the corresponding resistor layer 230 when the resistance modifying operation is performed to the upper electrode 240. Furthermore, thermal damages of heat energy of the laser to the resistor layer 230 can be efficiently prevented when the laser is merely applied to the upper electrode 240 or the lower electrode 220 (i.e. the laser is not applied to the resistor layer 230).

After the aforementioned operation 140 is performed, a protective layer, back electrodes and terminal electrodes can be further formed on the resistor body 200 to form the printing chip resistor of the present application.

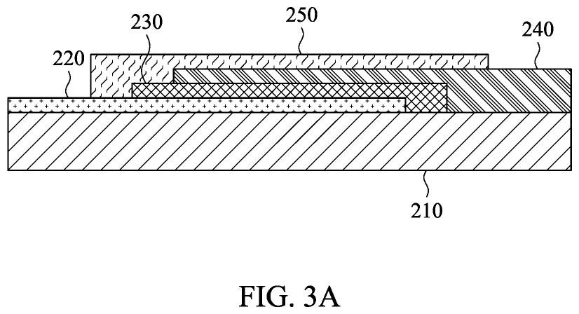

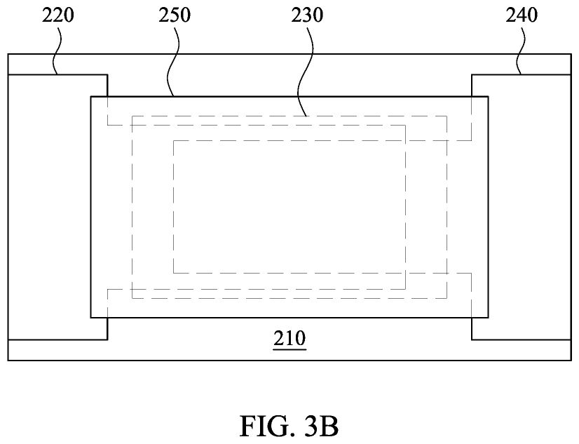

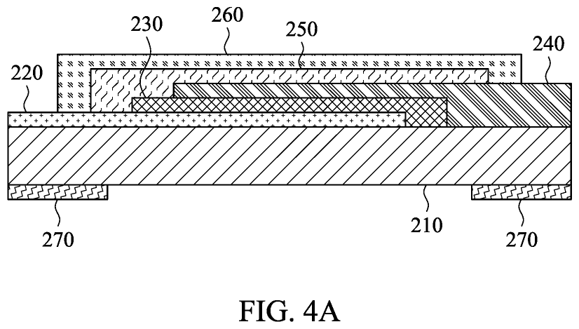

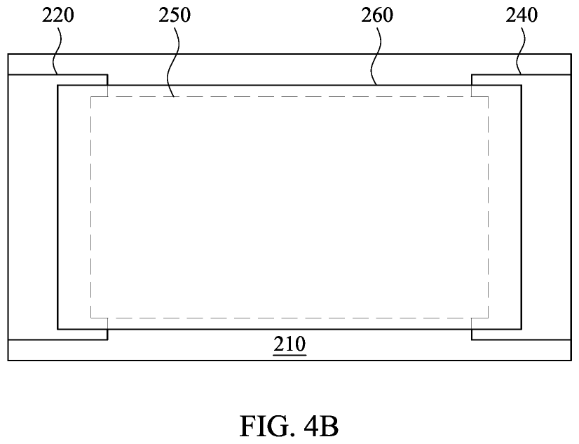

In some embodiments, for example, the protective layer can be a single layer or a composite layer formed of a plurality of sub-layers. For example, shown as FIG. 3A and FIG. 3B, and shown as FIG. 4A and FIG. 4B, a glass protective layer 250 and an epoxy protective layer 260 are sequentially formed on the upper electrode 240. The glass protective layer 250 completely covers the resistor layer 230 and covers a portion of the upper electrode 240 and a portion of the lower electrode 220. The epoxy protective layer 260 completely covers the glass protective layer 250. It can be realized that a portion of the lower electrode 220 and a portion of the upper electrode 240 do not be covered with the protective layer 250 after it has been formed, and therefore those portions can be used as electrical connection points of the printing chip resistor. Both of the glass protective layer 250 and the epoxy protective layer 260 can be formed with methods and materials well known to one skilled in the art rather than focusing or mentioning them in details.

As shown in FIG. 4A, two back electrodes 270 are formed on a bottom surface of the substrate 210, and corresponding to the upper electrode 240 and the lower electrode 220, the back electrodes 270 are respectively located at two ends of the substrate 210. In some examples, the back electrodes 270 can be formed by printing a low-temperature silver paste (such as containing metallic silver and epoxy resin) or sputtering, and materials of the back electrodes 270 can include but be not limited to nickel-chromium alloy (NiCr), copper-nickel alloy (CuNi), other copper alloys, other suitable alloy materials or a combination thereof. The formation of the back electrodes 270 is well known to one skilled in the art rather than focusing or mentioning them in details.

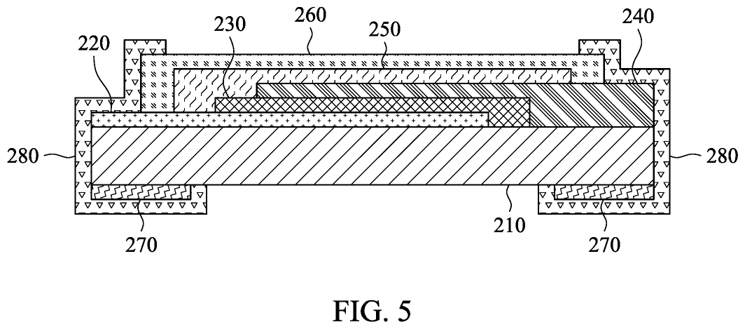

Shown as FIG. 5, two terminal electrodes 280 are respectively formed on two ends of the substrate 210 to form the printing chip resistor of the present application. One of the terminal electrodes 280 is electrically connected to the lower electrode 220 and the corresponding back electrode 270, and an other of the terminal electrodes 280 is electrically connected to the upper electrode 240 and the corresponding back electrode 270. It can be realized that the terminal electrodes 280 can be a single electrode layer formed of a single material or a composite electrode layer formed of a plurality of sub-layers which are formed from multiple materials. In some examples, the terminal electrodes 280 can be formed by sputtering, electroplating or other suitable methods, and materials of the terminal electrodes 280 can include but be not limited to NiCr, copper, tin, nickel, other suitable electrode materials or a combination thereof. For example, the terminal electrodes 280 can be a composite electrode layer. A NiCr sub-layer of the composite electrode layer is firstly formed by sputtering, and then a Ni sub-layer and a Sn sub-layer are sequentially formed by electroplating. The formation of the terminal electrodes 280 is well known to one skilled in the art rather than focusing or mentioning them in details.

According to the aforementioned description, in the printing chip resistor of the present application, the resistor layer is disposed between the upper electrode and the lower electrode to form the resistor body with a three-dimensional structure, and therefore the resistance path thereof is modified to conduct from the upper electrode above the resistor layer to the lower electrode below the resistor layer (vice versa). Thus, the path length is efficiently shortened, and the conduction cross-sectional area of the resistor is also enlarged by the laminated structure of the resistor layer and the two electrodes. Accordingly, the printing chip resistor of the present application can meet the requirements of low resistance value without adjusting the materials of the resistor layer. Moreover, the three-dimensional laminated structure facilitates to dissipate the heat energy generated from the resistor layer, thereby providing a better heat dissipation efficacy, and further printing chip resistor can efficiently resist current surges. Besides, the resistance modifying operation can be performed directly to the upper electrode and the lower electrode of the laminated structure to modify resistance properties, and the thermal damages of the heat energy to the resistor layer can be efficiently prevented.

As is understood by a person skilled in the art, the foregoing preferred embodiments of the present application are illustrated of the present application rather than limiting of the present application. In view of the foregoing, it is intended to cover various modifications and similar arrangements included within the spirit and scope of the appended claims. Therefore, the scope of which should be accorded the broadest interpretation so as to encompass all such modifications and similar structure.

What is claimed is:

1. A printing chip resistor, comprising:
a substrate;
a resistor layer disposed on a top surface of the substrate;
a lower electrode; and
an upper electrode, wherein along a direction perpendicular to the top surface, the lower electrode is disposed between the substrate and the resistor layer, and the resistor layer is disposed between the upper electrode and the lower electrode.

2. The printing chip resistor of claim 1, wherein at least one portion of the upper electrode overlaps at least one portion of the lower electrode.

3. The printing chip resistor of claim 2, wherein the resistor layer covers an overlapping area corresponding to the overlapping of the upper electrode and the lower electrode.

4. The printing chip resistor of claim 1, wherein the upper electrode and the lower electrode are respectively located at two ends of the substrate.

5. The printing chip resistor of claim 4, wherein the top surface is a square having a first side and a second side, the first side is perpendicular to the second side, and
along an extension direction of the first side, a length of the lower electrode is not greater than
$$\frac{4}{5} L 1 ,$$
wherein L1 represents a length of the first side; and
along an extending direction of the second side, a length of the lower electrode is not greater than
$$\frac{4}{5} L 2 ,$$
wherein L2 represents a length of the second side.

6. The printing chip resistor of claim 5, wherein the first side is longer than the second side, and
along the extending direction of the first side, the length of the lower electrode is not less than
$$\frac{1}{3} L 1.$$

7. The printing chip resistor of claim 2, wherein the upper electrode and the lower electrode are respectively located at two ends of the substrate.

8. The printing chip resistor of claim 7, wherein the top surface is a square having a first side and a second side, and the first side is perpendicular to the second side,
along an extension direction of the first side, a length of the lower electrode is not greater than
$$\frac{4}{5} L 1 ,$$
wherein L1 represents a length of the first side; and
along an extending direction of the second side, a length of the lower electrode is not greater than
$$\frac{4}{5} L 2 ,$$
wherein L2 represents a length of the second side.

9. The printing chip resistor of claim 1, further comprising:
a protective layer, disposed on the upper electrode, and the protective layer completely covers the resistor layer;
two back electrodes, respectively disposed at two ends on a bottom surface of the substrate; and
two terminal electrodes, respectively disposed at two ends of the substrate, wherein one of the two terminal electrodes is electrically connected to one of the two back electrodes and the lower electrode, and another one of the two terminal electrodes is electrically connected to another one of the lower electrode and the upper electrode.

10. A method for producing a printing chip resistor, comprising:
forming a lower electrode on a top surface of a substrate;
forming a resistor layer on the lower electrode; and
forming an upper electrode on the resistor layer to form a resistor body of the printing chip resistor, wherein along a direction perpendicular to the top surface, at least one portion of the upper electrode overlaps at least one portion of the lower electrode.

11. The method for producing the printing chip resistor of claim 10, wherein after forming the resistor body, the method further comprises:
performing a resistance modifying operation to the upper electrode and/or the lower electrode.

12. The method for producing the printing chip resistor of claim 10, wherein after forming the resistor body, the method further comprises:
forming a protection layer on the upper electrode, wherein the protection layer completely covers the resistor layer;
forming two back electrodes on a bottom surface of the substrate, wherein the two back electrodes are respectively located at two ends of the bottom surface; and
respectively forming two terminal electrodes on two ends of the substrate to form the printing chip resistor, wherein one of the two terminal electrodes is electrically connected to one of the two back electrodes and the lower electrode, and another one of the two terminal electrodes is electrically connected to another one of the two back electrodes and the upper electrode.

13. A printing chip resistor, comprising:
a substrate;
a lower electrode, disposed on a top surface of the substrate, and the lower electrode is located at a first side of the substrate;
an upper electrode, disposed on the lower electrode, and the upper electrode is located at a second side of the substrate, wherein the first side is different from the second side; and
a resistor layer, disposed between the lower electrode and the upper electrode, wherein the upper electrode and the lower electrode are electrically insulative,
along a direction perpendicular to the top surface, a projective area of the resistor layer covers an overlapping area where a projective area of the upper electrode overlaps a projective area of the lower electrode.

14. The printing chip resistor of claim 13, wherein the first side and the second side are opposite sides of the top surface of the substrate.

15. The printing chip resistor of claim 13, wherein the projective area of the resistor layer is not smaller than the overlapping area.

16. The printing chip resistor of claim 13, wherein the projective area of the resistor layer completely covers the overlapping area.

17. The printing chip resistor of claim 13, wherein the upper electrode and the resistor layer are directly disposed on the top surface of the substrate.

18. The printing chip resistor of claim 17, wherein the upper electrode and the resistor layer respectively includes:
a base portion, directly disposed on the top surface of the substrate; and
an extension portion,
along the direction perpendicular to the top surface, a projective area of the extension portion of the resistor layer, a projective area of the extension portion of the upper electrode and the projective area of the lower electrode are overlapping each other.
